(19) United States
(12) Patent Application Publication
(10) Pub. No.: US 2017/0160910 A1
(43) Pub. Date: Jun. 8, 2017

(54) METHOD AND ELECTRONIC DEVICE FOR SCREEN ADJUSTMENT

(71) Applicants: Le Holdings (Beijing) Co., Ltd., Beijing (CN); LE SHI INTERNET INFORMATION & TECHNOLOGY CORP.BEIJING, Beijing (CN)

(72) Inventor: Yue SHEN, Beijing (CN)

(21) Appl. No.: 15/250,619

(22) Filed: Aug. 29, 2016

Related U.S. Application Data
(63) Continuation of application No. PCT/CN2016/089072, filed on Jul. 7, 2016.

(30) Foreign Application Priority Data
Dec. 8, 2015 (CN) 201510898056.8

(51) Int. Cl. G06F 3/0484; G06F 3/0488; G06F 17/27; G06F 3/0482

(52) U.S. Cl. CPC G06F 3/04845; G06F 3/0482; G06F 3/0488; G06F 17/2705

(57) ABSTRACT

A method and an electronic device for screen adjustment are disclosed. The method for screen adjustment includes: detecting, by an electronic device, a screen adjustment event triggered by a user; parsing, by the electronic device, the screen adjustment event; searching, by the electronic device, a set correspondence table between a screen adjustment event and a screen size according to the parsed screen adjustment event, to acquire a screen size that matches the parsed screen adjustment event; and adjusting, by the electronic device, a displayed screen to the screen size that matches the parsed screen adjustment event.

### CROSS REFERENCE TO RELATED APPLICATION

This present disclosure is a continuation of International Disclosure No. PCT/CN2016/089072, filed on Jul. 7, 2016, which is based upon and claims priority to Chinese Patent Disclosure No. 201510898056.8, filed on Dec. 8, 2015, the entire contents of which are incorporated herein by reference.

### TECHNICAL FIELD

The disclosure relates to the field of intelligent terminals, and more particularly, to a method and an electronic device for screen adjustment.

### BACKGROUND

At present, people gain more and more convenience in their life with smart terminals such as smart phones and tablet computers. As science and technology keep developing nowadays, these smart terminals become increasingly popular in people's life and become necessities in people's life. While the functions of smart terminals gradually become powerful, display screens of these smart terminals also become increasingly larger. Large display screens can bring desirable visual effects and enhance user experience.

However, using a smart phone as an example, as a display screen becomes larger, it is increasingly difficult to operate the smart phone with one hand, and sometimes both hands are needed to operate the smart phone to accomplish a corresponding function. However, when the space is narrow or it is inconvenient to operate the smart phone with two hands, for example, during driving an automobile or a ride in a bus, a user may operate the smart phone by using only one hand. However, because the smart phone has an excessively large screen, when the smart phone is operated with one hand, some content on the screen cannot be touched and an operation of the user is affected. Therefore, smart phones that have large screens but cannot be operated with one hand put people to considerable inconvenience.

In view of this, embodiments of the present disclosure need to provide a method and electronic device for screen adjustment, such that when it is inconvenient for a user to perform an operation with both hands, the size of a displayed screen of an electronic device can be adjusted in a simple and convenient manner, so as to display a screen to the user according to the adjusted size of the displayed screen, making it convenient for the user to operate the electronic device having a large screen with one hand.

### SUMMARY

The present disclosure provide a method and an electronic device for screen adjustment, such that when it is inconvenient for a user to perform an operation with both hands, the size of a displayed screen of an electronic device can be adjusted in a simple and convenient manner, making it convenient for the user to operate the electronic device having a large screen with one hand.

An embodiment of the present disclosure provides a method for screen adjustment, including:

detecting, by an electronic device, a screen adjustment event triggered by a user;

parsing, by the electronic device, the screen adjustment event;

searching, by the electronic device, a set correspondence table between a screen adjustment event and a screen size according to the parsed screen adjustment event, to acquire a screen size that matches the parsed screen adjustment event; and

adjusting, by the electronic device, a displayed screen to the screen size that matches the parsed screen adjustment event.

An embodiment of the present disclosure provides an electronic device, including: at least one processor; and a memory communicably connected with the at least one processor for storing instructions executable by the at least one processor, wherein execution of the instructions by the at least one processor causes the at least one processor to:

detect a screen adjustment event triggered by a user and parse the screen adjustment event;

search a set correspondence table between a screen adjustment event and a screen size according to the parsed screen adjustment event, to acquire a screen size that matches the parsed screen adjustment event; and

adjust a displayed screen to the screen size that matches the parsed screen adjustment event.

An embodiment of the present disclosure further provides a non-transitory computer-readable storage medium storing executable instructions that, when executed by an electronic device, cause the electronic device to: detect, by an electronic device, a screen adjustment event triggered by a user;

parse, the screen adjustment event;

search, a set correspondence table between a screen adjustment event and a screen size according to the parsed screen adjustment event, to acquire a screen size that matches the parsed screen adjustment event; and

adjust, a displayed screen to the screen size that matches the parsed screen adjustment event.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale unless otherwise disclosed.

FIG. 1 is a flowchart illustrating a method for screen adjustment according to an embodiment of the present disclosure;

FIG. 2 is a schematic structural diagram illustrating a screen-adjusting electronic device according to an embodiment the present disclosure; and

FIG. 3 is a schematic structural diagram illustrating an electronic device according to the present disclosure.

### DETAILED DESCRIPTION

To make the objectives, technical solutions, and advantages of the embodiments of the present disclosure more clearly, the following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

FIG. 1 is a flowchart illustrating a method for screen adjustment according to an embodiment of the present disclosure. As illustrated in FIG. 1, this embodiment of the present disclosure provides a method for screen adjustment, including the following steps:

Step 11: An electronic device detects a screen adjustment event triggered by a user.

Step 13: The electronic device parses the screen adjustment event.

Step 15: The electronic device searches a set correspondence table between a screen adjustment event and a screen size according to the parsed screen adjustment event, to acquire a screen size that matches the parsed screen adjustment event.

Step 17: The electronic device adjusts a displayed screen to the screen size that matches the parsed screen adjustment event.

For the method for screen adjustment and the electronic device for screen adjustment provided in the embodiments of the present disclosure, a screen adjustment event is detected and parsed, and a screen adjustment size that matches the screen adjustment event is searched for and acquired, so as to adjust a displayed screen of an electronic device to the matching screen adjustment size, such that when it is inconvenient for a user to perform an operation with both hands, the size of a displayed screen of an electronic device can be adjusted in a simple and convenient manner, so as to display a screen to the user according to the adjusted size of the displayed screen, making it convenient for the user to operate the electronic device having a large screen with one hand.

In this embodiment of the present disclosure, the triggering a screen adjustment event may include, but is not limited to, the following three cases, which are specifically described below in detail.

In a first case, a sensing part is disposed on the electronic device in this embodiment of the present disclosure. The sensing part may be, for example, an infrared sensing part. When a hand of the user touches the infrared sensing part, a screen adjustment event is triggered. In this case, the detecting, by an electronic device, a screen adjustment event triggered by a user includes: touching, by the user, the sensing part to trigger the screen adjustment event, and detecting, by the electronic device, the screen adjustment event. The parsing, by the electronic device, the screen adjustment event includes: determining, by the electronic device, that the user touches the sensing part, and triggering, by the electronic device, a screen adjustment operation according to the screen adjustment event.

In the method for screen adjustment in this embodiment of the present disclosure, the sensing part may be disposed on a lateral surface, an upper portion or a rear surface of the electronic device, and as for which position is to choose, a basic principle is to facilitate an operation of a user. An effect of the sensing part includes that the sensing part is touched to trigger the screen adjustment operation. Because in this embodiment of the present disclosure, only an action of touching the sensing part is needed to trigger the screen adjustment operation, and the sensing part is disposed in a position, which is convenient to be operated by the user, on the electronic device, the action of touching the sensing part can also be easily accomplished even if it is inconvenient when the user is driving a car, taking a bus, or the like. Therefore, the method for screen adjustment in this embodiment of the present disclosure has simple operations, and a user can very conveniently implement a single-hand operation on an adjusted displayed screen.

In a second case, a screen adjustment switch is disposed on the electronic device; the detecting, by an electronic device, a screen adjustment event triggered by a user includes: touching, by the user, the screen adjustment switch to trigger the screen adjustment event, and detecting, by the electronic device, the screen adjustment event; and the parsing, by the electronic device, the screen adjustment event includes: determining, by the electronic device, that the screen adjustment switch is turned on, and triggering, by the electronic device, a screen adjustment operation according to the screen adjustment event.

In the method for screen adjustment provided in this embodiment of the present disclosure, the screen adjustment switch may be disposed on a lateral surface or a rear surface of the electronic device, and as for which position is to choose, a basic principle is to facilitate an operation of a user. An effect of the screen adjustment switch includes that when the screen adjustment switch is turned on, the screen adjustment operation can be triggered, and when the screen adjustment switch is turned off, a screen restoration operation can be triggered. Because in this embodiment of the present disclosure, only an action of turning on the screen adjustment switch is needed to trigger the screen adjustment operation, and the screen adjustment switch is disposed in a position, which is convenient to be operated by the user, on the electronic device, the action of turning on the screen adjustment switch can also be easily accomplished even if it is inconvenient when the user is driving a car, taking a bus, or the like. Therefore, the method for screen adjustment in this embodiment of the present disclosure has simple operations, and a user can very conveniently implement a single-hand operation on an adjusted displayed screen.

In a third case, a screen adjustment area is disposed on the displayed screen of the electronic device; the detecting, by an electronic device, a triggered screen adjustment event includes: touching, by the user, the screen adjustment area to trigger the screen adjustment event, and detecting, by the electronic device, the screen adjustment event; and the parsing, by the electronic device, the screen adjustment event includes: determining, by the electronic device, that the screen adjustment area is touched, and triggering, by the electronic device, a screen adjustment operation according to the screen adjustment event. The touching, by the user; the screen adjustment area to trigger the screen adjustment event includes: performing, by the user, a predefined operation in the screen adjustment area, where the performed predefined operation triggers the screen adjustment event.

In this embodiment of the method for screen adjustment according to the present disclosure, the screen adjustment area may be disposed in a middle portion or an upper portion of the screen, because with a normal single-hand operation, a middle portion area or an upper portion area of the screen cannot be touched. During specific setting, the size of the screen adjustment area may be calculated according to a screen adjustment size already set by the user. For example, if it is set that the screen adjustment size is to reduce the displayed screen to two thirds of the original screen, the screen adjustment area may be the one-third upper portion of the screen; if it is set that the screen adjustment size is to reduce the displayed screen to three fourths of the original screen, the screen adjustment area is the one-fourth upper portion of the screen; and so on. Certainly, if no screen adjustment size is set, a default value may be set for the screen adjustment area, and is, for example, the two-thirds upper portion of the screen.

In this embodiment of the present disclosure, the predefined operation performed on the screen adjustment area may include, but is not limited to, one of the manners such as that the user clicks the screen adjustment area, the user double clicks the screen adjustment area or the user draws a circle in the screen adjustment area. The electronic device triggers a screen adjustment trigger event according to the predefined operation of the user on the screen adjustment area, and the electronic device parses the screen adjustment trigger event to determine that the displayed screen of the electronic device needs to be adjusted. Therefore, the electronic device searches a corresponding relationship table between a screen adjustment trigger event and a screen size, and determines a screen size corresponding to the screen adjustment event, so as to adjust the displayed screen to the corresponding screen size, such that the user may perform a single-hand operation on the adjusted displayed screen.

In the method for screen adjustment in this embodiment of the present disclosure, only an action of a predefined operation on a screen adjustment area is needed to trigger screen adjustment, and the action of the predefined operation can also be easily accomplished even if it is inconvenient when the user is driving a car, taking a bus, or the like. Therefore, the method for screen adjustment in this embodiment of the present disclosure has simple operations, and a user can very conveniently implement a single-hand operation on an adjusted displayed screen.

In this embodiment of the present disclosure, the set correspondence table between a screen adjustment event and a screen size includes a corresponding relationship between different operations and different screen sizes. A specific corresponding relationship may be shown in Table 1 below, and is no longer elaborated herein in detail. Certainly, specific content shown in Table 1 is only a schematic example, and content setting in Table 1 may be adjusted according to an actual requirement. Table 1 may be saved in the electronic device, and the content in Table 1 is set by the user according to an actual requirement, and after being set, the specific content of Table 1 can be changed at any time, as long as a basic principle of facilitating an operation of a user is followed.

TABLE 1

| Screen adjustment trigger operation | Screen adjustment size |
|---|---|
| Sensing part is touched | One second of the original |
| | screen |
| Screen adjustment switch is turned on | ⅓ of the original screen |
| Screen adjustment area is touched | ¼ of the original screen |
| Predefined operation is performed on an | The original screen is displayed, |
| application icon of the game Minecraft | and the luminance is increased |
| Predefined operation is performed on an | ¼ of the original screen, and |
| application icon of WeChat | the luminance is increased |

In the method for screen adjustment in various embodiments of the present disclosure, when multiple screen adjustment sizes are set for a same screen adjustment operation, that is, when more than one screen size matches the parsed screen adjustment event, after the electronic device acquires a screen size that matches the parsed screen adjustment event shown in Table 1, the method in various embodiments of the present disclosure may further include: prompting, by the electronic device, the user to select the screen size that matches the parsed screen adjustment event. The electronic device receives a screen adjustment size selected by the user. The adjusting, by the electronic device, a displayed screen to the screen size that matches the parsed screen adjustment event includes: adjusting, by the electronic device, the displayed screen to the screen size that is selected by the user and matches the parsed screen adjustment event.

In this embodiment of the method for screen adjustment according to the present disclosure, a list of applications that are not to be displayed on an adjusted screen is set on the electronic device; before or after the searching, by the electronic device, a set correspondence table between a screen adjustment event and a screen size according to the parsed screen adjustment event, to acquire a screen size that matches the parsed screen adjustment event, the electronic device searches for and acquires the list of applications that are not to be displayed on an adjusted screen: and the adjusting, by the electronic device, a displayed screen to the screen size that matches the parsed screen adjustment event includes: avoiding displaying, on the displayed screen of the electronic device, an application listed in the acquired list of applications that are not to be displayed on an adjusted screen. That is, for applications listed on the displayed screen eventually presented to the user by the electronic device, applications listed in the list of applications that are not to be displayed on an adjusted screen have already been excluded.

Table 2 lists all applications that are expected by the user not to be displayed on the adjusted screen, and for the list of applications that are net to be displayed on an adjusted reference may be made to Table 2. The specific content of Table 2 is shown below, and is no longer elaborated herein in detail. Certainly, the specific content shown in Table 2 is only a schematic example, and the user may adjust content setting of Table 2 at any time according to an actual requirement of the user. Table 2 may be saved on the electronic device. The content of Table 2 is set by the user according to an actual requirement, and after being set, the specific content of Table 2 may be changed at any time, as long as a basic principle of facilitating an operation of a user is followed.

TABLE 2
Application that is not to be displayed after
the screen is adjusted

Minecraft
QQ chat

In this embodiment of the method for screen adjustment according to the present disclosure, the content of Table 2 may be further extended. For example, a corresponding relationship between an application that is expected by the user not to be displayed on an adjusted screen and the size of an adjusted screen is set in Table 3. Referring to the first row in Table 3, when the adjusted screen is one second of the original screen, the electronic device excludes, according to the size of the adjusted screen, the application “Minecraft” on the displayed screen displayed to the user. Similarly, referring to the second row in Table 3, when the adjusted screen is one third of the original screen, the electronic device excludes, according to the size of the adjusted screen, the application “QQ chat” on the displayed screen displayed to the user.

TABLE 3

| Application that is not | |
|---|---|
| to be displayed after the | |
| screen is adjusted | Screen adjustment size |
| Minecraft | ½ of the original screen |
| QQ chat | ⅓ of the original screen |

Table 3 lists a corresponding relationship between an application that is expected by the user not to be displayed on an adjusted screen and a size of the adjusted screen. For specific content, reference may be made to Table 3. Certainly, the specific content shown in Table 3 is only a schematic example, and the user may adjust content setting of Table 3 at any time according, to an actual requirement of the user. Table 3 may be saved on the electronic device. The content of Table 3 is set by the user according to an actual requirement, and after being set, the specific content of Table 3 may be changed at any time, as long as a basic principle of facilitating an operation of a user is followed.

In the method for screen adjustment in this embodiment of the present disclosure, an implementation solution about an application that is expected by the user not to be displayed is added, and more particularly, a detailed solution about an application that is expected by the user not to be displayed on an adjusted screen is added, such that eventually an application that is expected by the user not to be displayed is excluded on the screen displayed to the user by the electronic device. In the method for screen adjustment in this embodiment of the present disclosure, an actual requirement of the user is further fully considered, so as to further facilitate an operation of the user.

In the method for screen adjustment in this embodiment of the present disclosure, the step of prompting the user to select the screen adjustment size is added, and an actual requirement of the user is further considered, so as to further facilitate the operation of the user.

In the method for screen adjustment in various embodiments of the present disclosure, after the single-hand operation is finished, when the size of the screen needs to be increased, that is, when it is convenient for the user to perform an operation with both hands, the user may send an instruction of restoring the displayed screen to the electronic device. The electronic device restores the displayed screen of the electronic device to the original size according to the instruction of restoring the displayed screen sent by the user, that is, may implement that the user operates the electronic device with both hands. Certainly, in various embodiments of the present disclosure, the specific trigger method of restoring the screen size may include: receiving, by the electronic device, a predefined operation of the user on a blank area of the screen, to trigger an operation of the user to restore the size of the screen of the electronic device. The predefined operation on the blank area of the screen nay include, but is not limited to, one of the manners such as that the user clicks the blank area of the screen, the user double clicks the blank area of the screen, the user draws a circle in the blank area of the screen or the user turns off the screen adjustment switch.

Because in this embodiment of the present disclosure, only a predefined operation needs to be executed in the blank area of the screen to trigger the instruction of restoring the displayed screen, and the predefined operation or action is common click, double click or drawing. Moreover, the screen adjustment switch is disposed in a position convenient for the user to operate, and it is also very convenient to turn off the screen adjustment switch. Therefore, the action of restoring the screen size can also be easily accomplished even if it is inconvenient when the user is driving a car, taking a bus, or the like. Therefore, the method for restoring the displayed screen in this embodiment of the present disclosure has simple operations, and May enable a user to restore the size of the displayed screen very conveniently.

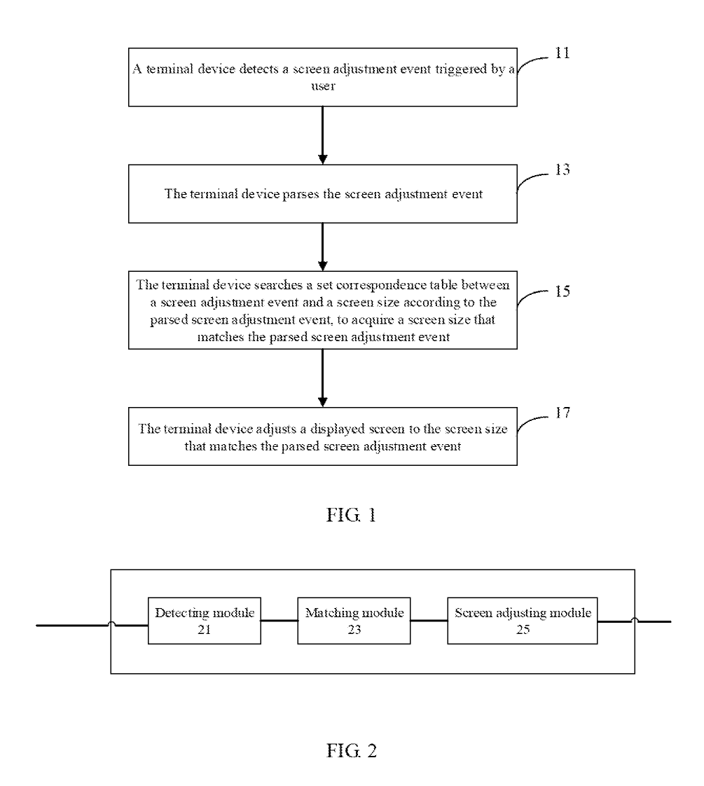

FIG. 2 is a schematic structural diagram illustrating a screen-adjusting electronic device according to an embodiment of the present disclosure. As illustrated in FIG. 2, this embodiment of the present disclosure provides the screen-adjusting electronic device, including a detecting module 21, a matching module 23, and a screen adjusting module 25. The detecting module 21 detects a screen adjustment event triggered by a user and parses the screen adjustment event; the matching module 23 searches a set correspondence table between a screen adjustment event and a screen size according to the parsed screen adjustment event, to acquire a screen size that matches the parsed screen adjustment event; and the screen adjusting module 25 adjusts a displayed screen to the screen size that matches the parsed screen adjustment event.

The screen-adjusting electronic device according to this embodiment of the present disclosure detects and parses a screen adjustment event, and searches for and acquires a screen adjustment size that matches the screen adjustment event, so as to adjust a displayed screen of an electronic device to the matching screen adjustment size, such that when it is inconvenient for a user to perform an operation with both hands, the size of a displayed screen of an electronic device can be adjusted in a simple and convenient manner, so as to display a screen to the user according to the adjusted size of the displayed screen, making it convenient for the user to operate the electronic device having a large screen with one hand.

A sensing part (not shown) may be disposed on the screen-adjusting electronic device in this embodiment of the present disclosure. The sensing part may be, for example, an infrared sensing part. When a hand of the user touches the infrared sensing part, a screen adjustment event is triggered. In this case, that the detecting module 21 of the electronic device detects a screen adjustment event triggered by a user includes: touching, by the user, the sensing part the screen adjustment event, and detecting, by the detecting module 21 of the electronic device, the screen adjustment event. That the detecting module 21 of the electronic device parses the screen adjustment event includes: determining, by the detecting module 21 of the electronic device, that the user touches the sensing part, and triggering, by the detecting module 21 of the electronic device, a screen adjustment operation according to the screen adjustment event.

In the screen-adjusting electronic device in this embodiment of the present disclosure, the sensing part may be disposed on a lateral surface, an upper portion or a rear surface of the electronic device, and as for which position is to choose, a basic principle is to facilitate an operation of a user. An effect of the sensing part includes that the sensing part is touched to trigger the screen adjustment operation. Because in this embodiment of the present disclosure, only an action of touching the sensing part is needed to trigger the screen adjustment operation, and the sensing part is disposed in a position, which is convenient to be operated by the user, on the electronic device, the action of touching the sensing part can also be easily accomplished even if it is inconvenient when the user is driving a car, taking a bus, or the like. Therefore, the screen adjustment method in this embodiment of the present disclosure has simple operations, and a user can very conveniently implement a single-hand operation on an adjusted displayed screen.

A screen adjustment switch (not shown) is disposed on the screen-adjusting electronic device in this embodiment of the present disclosure. That the detecting module 21 detects a screen adjustment event triggered by a user includes: touching, by the user, the screen adjustment switch to trigger the screen adjustment event, and the detecting module 21 detects the screen adjustment event; and that the detecting module 21 parses the screen adjustment event includes: determining, by the detecting module 21, that the screen adjustment switch is turned on, and triggering, by the detecting module 21, a screen adjustment operation according to the screen adjustment event.

In the screen-adjusting electronic device in this embodiment of the present disclosure, the screen adjustment switch may be disposed on a lateral surface or a rear surface of the electronic device, and as for which position is to choose, a basic principle is to facilitate an operation of a user. An effect of the screen adjustment switch includes that when the screen adjustment switch is turned on, the screen adjustment operation can be triggered, and when the screen adjustment switch is turned off, a screen restoration operation can be triggered. Because in this embodiment of the present disclosure, only an action of turning on the screen adjustment switch is needed to trigger the screen adjustment operation, and the screen adjustment switch is disposed in a position, which is convenient to be operated by the user, on the electronic device, the action of turning on the screen adjustment switch can also be easily accomplished even if it is inconvenient when the user is driving a car, taking a bus, or the like. Therefore, the screen-adjusting electronic device in this embodiment of the present disclosure has simple operations during screen adjustment, and a user can very conveniently implement a single-hand operation on an adjusted displayed screen.

A screen adjustment area (not shown) is disposed on the displayed screen of the screen-adjusting electronic device in this embodiment of the present disclosure. That the detecting module 21 detects a triggered screen adjustment event includes: touching, by the user, the screen adjustment area to trigger the screen adjustment event, and detecting, by the detecting module 21, the screen adjustment event; and that the detecting module 21 parses the screen adjustment event includes: determining, by the detecting module, that the screen adjustment area is touched, and triggering, by the detecting, module 21, a screen adjustment operation according to the screen adjustment event. The touching, by the user, the screen adjustment area to trigger the screen adjustment event includes: performing, by the user, a predefined operation in the screen adjustment area, where the performed predefined operation triggers the screen adjustment event.

In this embodiment of the screen-adjusting electronic device according to the present disclosure, the user sets the size of the screen adjustment area in the detecting module 21. The screen adjustment area may be disposed in a middle portion or an upper portion of the screen, because with a normal single-hand operation, a Middle portion area or an upper portion area of the screen cannot be touched. During specific setting, the size of the screen adjustment area may be calculated according to a screen adjustment size already set by the user. For example, if it is set that the screen adjustment size is to reduce the displayed screen to two thirds of the original screen, the screen adjustment area may be the one-third upper portion of the screen; if it is set that the screen adjustment size is to reduce the displayed screen to three fourths of the original screen, the screen adjustment area is the one-fourth upper portion of the screen; and so on. Certainly, if no screen adjustment size is set, a default value may be set for the screen adjustment area, and is, for example, the two-thirds upper portion of the screen.

In this embodiment of the present disclosure, the predefined operation performed on the screen adjustment area may include, but is not limited to, one of the manners such as that the user clicks the screen adjustment area, the user double clicks the screen adjustment area or the user draws a circle in the screen adjustment area. The electronic device triggers a screen adjustment trigger event according to the predefined operation of the user on the screen adjustment area, and the electronic device parses the screen adjustment trigger event to determine that the displayed screen of the electronic device needs to be adjusted. Therefore, the electronic device searches a corresponding relationship table between a screen adjustment trigger event and a screen size, and determines a screen size corresponding to the screen adjustment event, so as to adjust the displayed screen to the corresponding screen size, such that the user may perform a single-hand operation on the adjusted displayed screen.

For the screen-adjusting electronic device in this embodiment of the present disclosure, only an action of a predefined operation on a screen adjustment area is needed to trigger screen adjustment, and the action of the predefined operation can also be easily accomplished even if it is inconvenient when the user is driving a car, taking a bus, or the like. Therefore, the method for screen adjustment in this embodiment of the present disclosure has simple operations, and a user can very conveniently implement a single-hand operation on an adjusted displayed screen.

In the screen-adjusting electronic device in this embodiment of the present disclosure, the user may set a corresponding relationship table between a screen adjustment event and a screen size in the matching module 21 of the electronic device, and for specific content of the corresponding relationship table, reference may be made to the foregoing description of Table 1.

In this embodiment of the screen-adjusting electronic device according to the present disclosure, a list of applications that are not to be displayed on an adjusted screen is set on the matching module 23; before or after the matching module 23 searches a set correspondence table between a screen adjustment event and a screen size according to the parsed screen adjustment event, to acquire a screen size that matches the parsed screen adjustment event, the matching module searches for and acquires the list of applications that are not to be displayed on an adjusted screen; and that the screen adjusting module adjusts a displayed screen to the screen size that matches the parsed screen adjustment event includes: avoiding displaying, on the displayed screen of the electronic device, an application listed in the acquired list of applications that are not to be displayed on an adjusted screen. That is, for applications listed on the displayed screen eventually presented to the user by the screen adjusting module, applications listed in the list of applications that are not to be displayed on an adjusted screen have already been excluded. Reference may be made to the foregoing description of Table 2 for specific content of the application that is expected by the user not to be displayed on an adjusted screen, and the specific content is no longer elaborated herein.

In this embodiment of the screen-adjusting electronic device according to the present disclosure, the content of Table 2 may be further extended. As shown in Table 3, reference may be made to the foregoing description of Table 3 for the specific content of an application that is expected by the user not to be displayed on the adjusted screen, and the specific content is no longer elaborated herein. Certainly, being the same as Table 1, Table 2 and Table 3 may be set in the matching module 23 of the electronic device.

In the screen-adjusting electronic device in this embodiment of the present disclosure, an implementation solution about an application that is expected by the user not to be displayed is added, and more particularly, a detailed solution about an application that is expected by the user not to be displayed on an adjusted screen is added, such that eventually an application that is expected by the user not to be displayed is excluded on the screen displayed to the user by the electronic device. In the screen adjustment device in this embodiment of the present disclosure, an actual requirement of the user is further fully considered, so as to further facilitate an operation of the user.

In the screen-adjusting electronic device in various embodiments of the present disclosure, when the matching module 23 acquires that multiple screen adjustment sizes are set for a same screen adjustment operation, that is, when more than one screen size matches the parsed screen adjustment event, after the matching module 23 of the electronic device acquires a screen size that matches the parsed screen adjustment event as shown in Table 1, the matching module 23 is further configured to prompt the user to select the screen size that matches the parsed screen adjustment event; and that the screen adjusting module 25 adjusts a displayed screen to the screen size that matches the parsed screen adjustment event includes: adjusting, by the screen adjusting module 25, the displayed screen to the screen size that is selected by the user and matches the parsed screen adjustment event. The screen adjusting module 25 is further configured to receive a predefined operation of the user on a blank area of the screen, to trigger an operation of the user to restore the size of the screen of the electronic device.

In the screen-adjusting electronic device in various embodiments of the present disclosure, after the single-hand operation is finished, when the size of the screen needs to be increased, that is, when it is convenient for the user to perform an operation with both hands, the user may send an instruction of restoring the displayed screen to the electronic device, the matching module 23 of the electronic device instructs, according to the instruction of restoring the displayed screen sent by the user, the screen adjusting module to restore the displayed screen of the electronic device to the original size, that is, may implement that the user operates the electronic device with both hands. Certainly, in various embodiments of the present disclosure, the specific trigger method of restoring the screen size may include: receiving, by the electronic device, a predefined operation of the user on a blank area of the screen, to trigger an operation of the user to restore the size of the screen of the electronic device. The predefined operation on the blank area of the screen may include, but is not limited to, one of the manners such as that the user clicks the blank area of the screen, the user double clicks the blank area of the screen, the user draws a circle in the blank area of the screen or the user turns off the screen adjustment switch.

Because in this embodiment of the present disclosure, only a predefined operation needs to be executed in the blank area of the screen to trigger the instruction of restoring the displayed screen, and the predefined operation or action is common click, double click or drawing. Moreover, the screen adjustment switch is disposed in a position convenient for the user to operate, and it is also very convenient to turn off the screen adjustment switch. Therefore, the action of restoring the screen size can also be easily accomplished even if it is inconvenient when the user is driving a car, taking a bus, or the like. Therefore, the screen-adjusting electronic device in this embodiment of the present disclosure has very simple operations during restoration of the displayed screen, and may enable a user to restore the size of the displayed screen very conveniently.

The screen-adjusting electronic device in various embodiments of the present disclosure includes, but is not limited to, a touch-screen control device such as a smart phone and a PAD.

For the method for screen adjustment in this embodiment of the present disclosure, a hardware processor may be used to implement related functions. When the hardware processor executes the method for screen adjustment provided in the embodiments of the present disclosure, the following processing may be included: detecting, by an electronic device, a screen adjustment event triggered by a user; parsing, by the electronic device, the screen adjustment event; searching, by the electronic device, a set correspondence table between a screen adjustment event and a screen size according to the parsed screen adjustment event, to acquire a screen size that matches the parsed screen adjustment event; and adjusting, by the electronic device, a displayed screen to the screen size that matches the parsed screen adjustment event. In the method for screen adjustment provided in the embodiments of the present disclosure, a screen adjustment event is detected and parsed, and a screen adjustment size that matches the screen adjustment event is searched for and acquired, so as to adjust a displayed screen of an electronic device to the matching screen adjustment size, such that when it is inconvenient for a user to perform an operation with both hands, the size of a displayed screen of an electronic device can be adjusted in a simple and convenient manner, so as to display a screen to the user according to the adjusted size of the displayed screen, making it convenient for the user to operate the electronic device having a large screen with one hand.

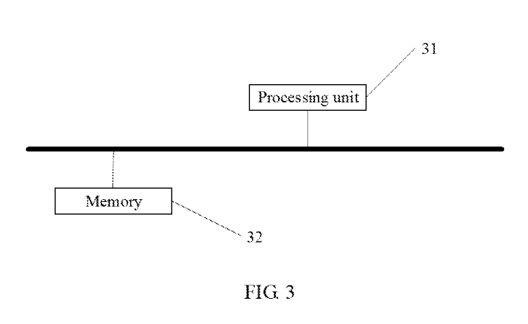

Referring to FIG. 3, another embodiment of the present disclosure further provides an electronic device, which has the same functions as those of the apparatus illustrated in FIG. 2. The device as illustrated in FIG. 3 includes at least one central processing unit 31 and a memory 32. The memory 32 and the at least one central processing unit 31 are connected via a bus. The memory 32 is configured to store computer instructions. When the apparatus is executed, the at least one central processing unit 31 performs the computer instructions stored in the memory to cause the apparatus to perform the steps in the methods as illustrated in FIG. 1.

Another embodiment of the present disclosure further provides a non-transitory computer-readable storage medium storing executable instructions that, when executed by an electronic device, cause the electronic device to: detecting, by an electronic device, a screen adjustment event triggered by a user; parsing, by the electronic device, the screen adjustment event; searching, by the electronic device, a set correspondence table between a screen adjustment event and a screen size according to the parsed screen adjustment event, to acquire a screen size that matches the parsed screen adjustment event; and adjusting, by the electronic device, a displayed screen to the screen size that matches the parsed screen adjustment event.

The described apparatus embodiment is merely exemplary. The modules described as separate parts may or may not be physically separated, and parts shown as modules may or may not be physical modules, which may be located in one position, or may be distributed on multiple network modules. A part of or all of the modules may be selected according to actual needs to achieve the objectives of the solutions of the embodiments. A person of ordinary skill in the art may understand implement the embodiments without creative efforts.

As can be known from the description of the foregoing implementation manners, a person skilled in the art may clearly understand that the implementation manners may be implemented by using software plus a necessary universal hardware platform or may certainly be implemented by using hardware. Based on such an understanding, the foregoing technical solutions essentially, or the part contributing, to the related art may be implemented in the form of a software product. The computer software product may be stored in a computer readable recording medium, such as a ROM/RAM, a magnetic disk, or an optical disc, and includes several instructions for instructing a computer device (which may be a personal computer, a server, or a network device) to perforin all the embodiments or some parts of the embodiments.

Finally, it should be noted that the foregoing embodiments are merely intended for describing the technical solutions of the present disclosure rather than limiting the present disclosure. Although the present disclosure is described in detail with reference to the foregoing embodiments, a person of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. A method for screen adjustment, comprising: at an electronic device:
detecting, by an electronic device, a screen adjustment event triggered by a user;
parsing, by the electronic device, the screen adjustment event;
searching, by the electronic device, a set correspondence table between a screen adjustment event and a screen size according to the parsed screen adjustment event, to acquire a screen size that matches the parsed screen adjustment event; and
adjusting, by the electronic device, a displayed screen to the screen size that matches the parsed screen adjustment event.

2. The method according to claim 1, wherein
a sensing part is disposed on the electronic device;
the detecting, by an electronic device, a screen adjustment event triggered by a user comprises: touching, by the user, the sensing part to trigger the screen adjustment event, and detecting, by the electronic device, the screen adjustment event; and
the parsing, by the electronic device, the screen adjustment event comprises: determining, by the electronic device, that the user touches the sensing part, and triggering, by the electronic device, a screen adjustment operation according to the screen adjustment event.

3. The method according to claim 1, wherein
a screen adjustment switch is disposed on the electronic device;
the detecting, by an electronic device, a screen adjustment event triggered by a user comprises: touching, by the user, the screen adjustment switch to trigger the screen adjustment event, and detecting, by the electronic device, the screen adjustment event; and
the parsing, by the electronic device, the screen adjustment event comprises: determining, by the electronic device, that the screen adjustment switch is turned on, and triggering, by the electronic device, a screen adjustment operation according to the screen adjustment event.

4. The method according to claim 1, wherein
a screen adjustment area is disposed on the displayed screen of the electronic device;
the detecting, by an electronic device, a triggered screen adjustment event comprises: touching, by the user, the screen adjustment area to trigger the screen adjustment event, and detecting, by the electronic device, the screen adjustment event; and
the parsing, by the electronic device, the screen adjustment event comprises: determining, by the electronic device, that the screen adjustment area is touched, and triggering, by the electronic device, a screen adjustment operation according to the screen adjustment event.

5. The method according to claim 4, wherein
the touching, by the user, the screen adjustment area to trigger the screen adjustment event comprises: performing, by the user, a predefined operation in the screen adjustment area, wherein the performed predefined operation triggers the screen adjustment event.

6. The method according to any one of claim 1, wherein
a list of disclosures that are not to be displayed on an adjusted screen is set on the electronic device;
before or after the searching, by the electronic device, a set correspondence table between a screen adjustment event and a screen size according to the parsed screen adjustment event, to acquire a screen size that matches the parsed screen adjustment event, the electronic device searches for and acquires the list of disclosures that are not to be displayed on an adjusted screen; and
the adjusting, by the electronic device, a displayed screen to the screen size that matches the parsed screen adjustment event comprises: avoiding displaying, on the displayed screen of the electronic device, an disclosure listed in the acquired list of disclosures that are not to be displayed on an adjusted screen.

7. The method according to any one of claim 1, wherein
the set correspondence table between a screen adjustment event and a screen size comprises a corresponding relationship between different operations and different screen sizes.

8. The method according to any one of claim 1, wherein
after the electronic device acquires the screen size that matches the parsed screen adjustment event, the method further comprises: prompting, by the electronic device, the user to select the screen size that matches the parsed screen adjustment event; and
the adjusting, by the electronic device, a displayed screen to the screen size that matches the parsed screen adjustment event comprises: adjusting, by the electronic device, the displayed screen to the screen size that is selected by the user and matches the parsed screen adjustment event.

9. The method according to any one of claim 1, wherein
the method further comprises: receiving, by the electronic device, a predefined operation of the user on a blank area of the screen, to trigger an operation of the user to restore the size of the screen of the electronic device.

10. An electronic device, comprising:
at least one processor; and
a memory communicably connected with the at least one processor for storing instructions executable by the at least one processor, wherein execution of the instructions by the at least one processor causes the at least one processor to:
detect a screen adjustment event triggered by a user and parse the screen adjustment event;
search a set correspondence table between a screen adjustment event and a screen size according to the parsed screen adjustment event, to acquire a screen size that matches the parsed screen adjustment event; and
adjust a displayed screen to the screen size that matches the parsed screen adjustment event.

11. The electronic device according to claim 10, wherein
a sensing part is disposed on the electronic device;
the step to detect a screen adjustment event triggered by a user comprises: touching, by the user, the sensing part to trigger the screen adjustment event, and detecting the screen adjustment event; and
the step to parse the screen adjustment event comprises: determining, that the user touches the sensing part, and triggering a screen adjustment operation according to the screen adjustment event.

12. The electronic device according to claim 10, wherein
a screen adjustment switch is disposed on the electronic device;
the step to detect a screen adjustment event triggered by a user comprises: touching, by the user, the screen adjustment switch to trigger the screen adjustment event, and detecting the screen adjustment event; and
the step to parse the screen adjustment event comprises: determining, the screen adjustment s itch is turned on, and triggering a screen adjustment operation according to the screen adjustment event.

13. The electronic device according to claim 10, wherein
a screen adjustment area is disposed on the displayed screen of the electronic device;
the step to detect a trigger screen adjustment event comprises: touching, by the user, the screen adjustment area to trigger the screen adjustment event, and detecting the screen adjustment event; and
the step to parse the screen adjustment event comprises: determining that the screen adjustment area is touched, and triggering, a screen adjustment operation according to the screen adjustment event.

14. The electronic device according to claim 13, wherein
the touching, by the user, the screen adjustment area to trigger the screen adjustment event further comprises: performing, by the user, a predefined operation in the screen adjustment area, wherein the performed predefined operation triggers the screen adjustment event.

15. The electronic device according to any one of claim 10, wherein
a list of applications that are not to be displayed on an adjusted screen is set;
before or after searching a set correspondence table between a screen adjustment event and a screen size according to the parsed screen adjustment event, acquiring a screen size that matches the parsed screen adjustment event, searching for and acquiring the list of applications that are not to be displayed on an adjusted screen; and
adjusting a displayed screen to the screen size that matches the parsed screen adjustment event comprises: avoiding displaying, on the displayed screen, an application listed in the acquired list of applications that are not to be displayed on an adjusted screen.

16. The electronic device according to any one of claim 10, wherein
the set correspondence table between a screen adjustment event and a screen size comprises a corresponding relationship between different operations and different screen sizes.

17. The electronic device according to any one of claim 10, wherein
after acquiring the screen size that matches the parsed screen adjustment event, the at least one processor is further caused to: prompt the user to select the screen size that matches the parsed screen adjustment event; and
the step to adjust a displayed screen to the screen size that matches the parsed screen adjustment event comprises: adjusting the displayed screen to the screen size that is selected by the user and matches the parsed screen adjustment event.

18. The electronic device according to any one of claim 10, wherein the at least one processor is further caused to:
receive a predefined operation of the user on a blank area of the screen, to trigger an operation of the user to restore the size of the screen of the electronic device.

19. A non-transitory computer-readable storage medium storing executable instructions that, when executed by an electronic device with a touch-sensitive display, cause the electronic device to:
detect a screen adjustment event triggered by a user;
parse the screen adjustment event;
search a set correspondence table between a screen adjustment event and a screen size according to the parsed screen adjustment event, to acquire a screen size that matches the parsed screen adjustment event; and
adjust a displayed screen to the screen size that matches the parsed screen adjustment event.
